(19) United States
(12) Patent Application Publication
(10) Pub. No.: US 2004/0211848 A1
(43) Pub. Date: Oct. 28, 2004

(54) Coffee grinder with removable bin

(75) Inventors: Theodore B. Mulle, New Milford, CT (US); David J. Wanat, Merdien, CT (US)

Correspondence Address: Charles N.J. Ruggiero, Esq., Ohlandt , Greeley, Ruggiero & Perle, L.L.P., 10th Floor, One Landmark Square, Stamford, CT, 06901-2682, US

(73) Assignee: CONAIR CORPORATION

(21) Appl. No.: 10/423,763

(22) Filed: Apr. 25, 2003

(51) Int. Cl. A47J 42/00

(52) U.S. Cl. 241/36

(57) ABSTRACT

A coffee grinder having a grinder bin for containing an amount of coffee beans therein, a grinder base for supporting the grinder bin disposed on an upper surface area of the grinder base, and a grinder lid for covering the grinder bin disposed on the grinder base is provided. The grinder bin is removably connected to the grinder base.

### BACKGROUND OF THE INVENTION

1. Field of the Invention

The present invention relates to a coffee grinder. More particularly, the present invention relates to a coffee bean grinder having a removable bin for containing the coffee beans.

2. Description of the Related Art

In the prior art, there are known commercial grade coffee grinders for use in restaurants and other high volume business environments. Commercial grade coffee grinders tend to be large and expensive to own and operate. Commercial grade coffee grinders also tend to be difficult and cumbersome to maintain and clean. Personal/consumer coffee grinders also tend to be cumbersome and difficult to clean since the grinder bin is an integral (i.e., fixed) part of the coffee grinder.

While many people savor the flavor of coffee attained from freshly ground coffee beans, the expense and time required to set-up, use, and clean the coffee grinder is viewed as too cumbersome and time-consuming for many coffee drinkers.

Therefore, there exists a need to provide a coffee bean grinder that is easily and safely operated, including unloading ground coffee from the grinder bin and cleaning of the grinder bin.

### SUMMARY OF THE INVENTION

It is an object of the present invention to provide a coffee grinder being easily activated and controlled.

It is another object of the present invention to provide such a coffee grinder having a removable grinder bin.

It is still another object of the present invention to provide such a coffee grinder that facilitates convenient unloading and cleaning of the grinder bin.

The present invention includes a coffee grinder having a grinder bin for containing an amount of coffee beans therein, a grinder base for supporting the grinder bin disposed on an upper surface area of the grinder base, and a grinder lid for covering the grinder bin disposed on the grinder base, where the grinder bin is removably attached to the grinder base.

The above and other objects, advantages, and benefits of the present invention will be understood by reference to following detailed description and appended sheets of drawings.

### BRIEF DESCRIPTION OF THE DRAWINGS

FIG. 1 is a top perspective view of a coffee grinder having a removable grinder bin in accordance with the present invention;

FIG. 2 is an exploded view of the coffee grinder shown in FIG. 1, depicting some of the major components thereof;

FIG. 3 is an exploded view of the coffee grinder shown in FIG. 1, depicting in detail substantially all of the components thereof; and

FIG. 4 is a perspective view of the coffee grinder shown in FIG. 1, including a partial cut-away of the grinder lid to illustrate the switch mechanism thereof.

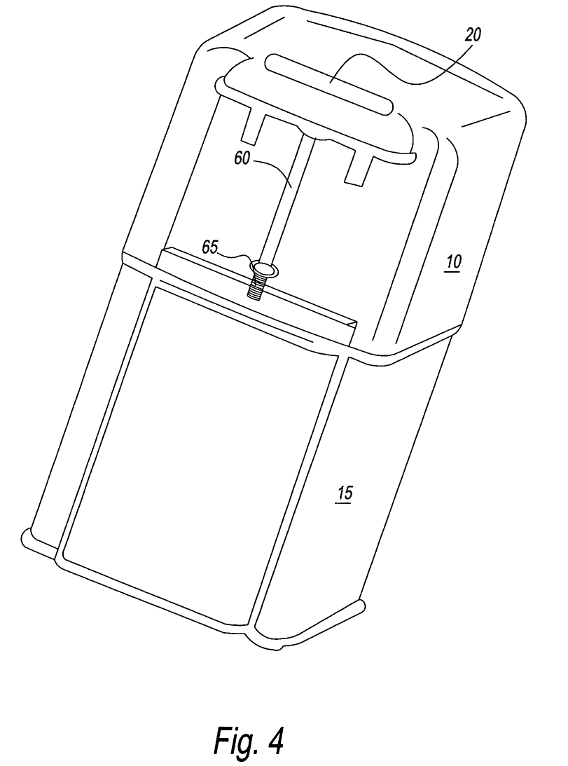

### DETAILED DESCRIPTION OF THE INVENTION

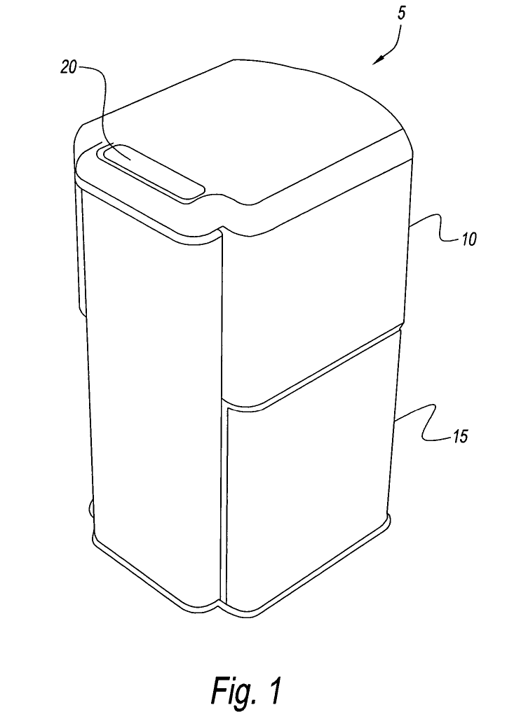

Referring to the drawings and in particular FIG. 1, there is provided a coffee grinder generally represented by reference numeral 5. The coffee grinder 5 has a grinder lid 10 and a grinder base 15. Grinder lid 10 has a switch actuator 20 incorporated therewith. In one aspect of the present invention, switch actuator 20 is integrally incorporated into grinder lid 10, thereby providing, for example, a reliable switch actuator.

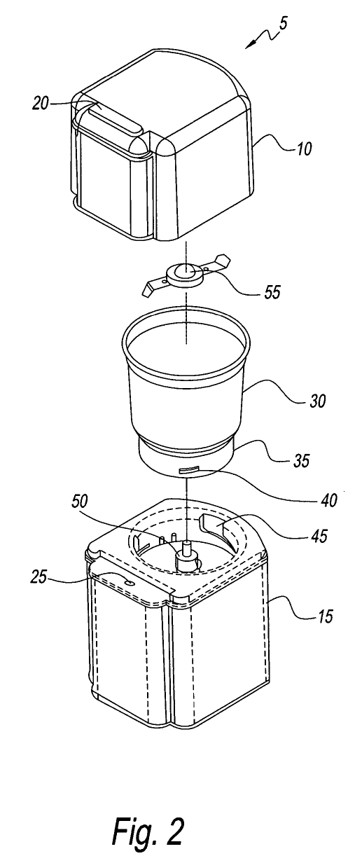

Grinder lid 10 can be selectively disposed on and removed from atop of grinder base 15. As depicted in FIG. 1, grinder lid 10 is disposed on grinder base 15. Referring to FIG. 2, it is shown that grinder lid 10 is removed from (i.e., not disposed on or connected to) grinder base 15. Grinder lid 10 can, in one aspect hereof, be selectively and removably connected to grinder base 15 without the necessity of engaging a lock, a clamp, or other type of faster. Accordingly, grinder lid 10 may be easily removed and connected to grinder base 15.

In an aspect of the present invention, grinder lid 10 and grinder base 15 are shaped such that the proper orientation of the grinder lid and the grinder base can be quickly and easily determined. Proper orientation of grinder lid 10 and grinder base 15 is desired to facilitate operation of grinder 5, as will be discussed in greater detail below. Regarding the shape of grinder lid 10 and grinder base 15, the grinder lid and the grinder base may be asymmetrically shaped as depicted in the accompanying figures to provide an indication of the relative orientation between the grinder lid and the grinder base in order to properly align the grinder lid and base when connecting the grinder lid on the grinder base.

It should be appreciated that a visual indicator and/or mechanical means (e.g., grinder lid 10 is “keyed” to mate with grinder base 15 in a specific orientation) can be used in lieu of or in combination with the shaped grinder lid and base to achieve the proper, desired orientation between the grinder lid and the grinder base in the instance that grinder lid and base are mated together.

Coffee grinder 5 includes a grinder bin 30 that is removably disposed in a recess provided in grinder base 15. Grinder bin 30 provides a holding container for coffee beans operatively ground by coffee grinder 5. Grinder bin 30 may act as a holding container for the coffee beans before they are ground, while they are being ground, and after they are ground.

In an aspect of the present invention, grinder bin 30 has connected thereto a grinder bin base 35, a blade assembly 55 for grinding coffee beans disposed in grinder bin 30, and a coupling 57 for securing the grinder bin, grinder bin base 35, and blade assembly 55 together. Coupling 57 provides an interface between a motor 85 for driving the blade assembly and grinder bin 30.

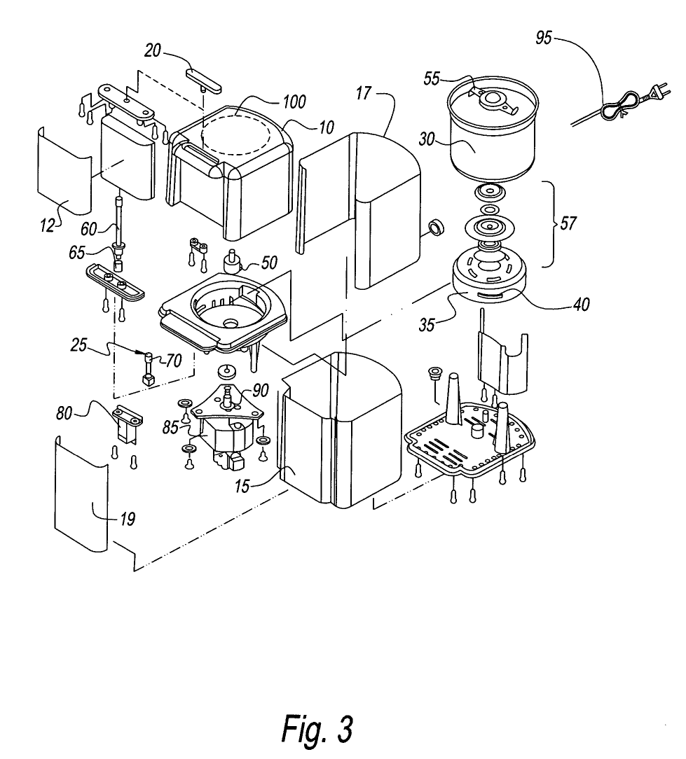

Details of an exemplary configuration for coupling 57 are depicted in FIG. 3. Certain details of the configuration of coupling 57 may be varied within the scope of the present invention, such as, for example the particular order and size of bushings, etc. comprising the coupling. In one aspect hereof, blade assembly 55 is preferably threaded onto or otherwise removably connected to coupling 57. In this manner, blade assembly 55 may be selectively removed (i.e., disengaged) from grinder bin 30 and coupling 57 for the purpose of, for example, cleaning and sharpening blade assembly 55.

In another aspect of the present invention, grinder bin 30 may be conveniently cleaned by removing the grinder bin from grinder base 15 and cleaning the grinder bin by, for example, rinsing grinder bin in soapy water.

Grinder bin 30, including grinder bin base 35 connected thereto, is preferably removably connected to grinder base 15 in a secure manner to facilitate safe and reliable operation of coffee grinder 5. To increase the operational safety and reliability of coffee grinder 5, it is desired that grinder bin 30 is securely held in position within grinder base 15 during the grinding process provided by the coffee grinder. Tabs 40 (only one shown) located on grinder bin base 35 are provided to engage with cammed (i.e., angled) slots 45 of grinder base 15 such that grinder bin 30 can be removably secured to the grinder base via a “twist-lock” maneuver. The twist-lock maneuver entails sitting tabs 40 in the open, wide end of cammed slots 45 and turning grinder bin 30 such that the grinder bin is urged into a locked, secure position as the grinder bin is turned and tabs 40 are acted upon by the cammed slots.

It should be appreciated that other means and methods of securing grinder bin 30 to grinder base 15 may be used in lieu of and in combination with the cammed slots 45 and cooperating tabs 40 discussed above. For example, each of tabs 40 and cammed slots 45 can be cammed (i.e., slanted).

Regarding the operation of coffee grinder 5 and referring to FIGS. 1-3, the exemplary actuator 20 is provided to actuate a master on/off switch of the coffee grinder. Movement of actuator 20 is transferred to a switch 80 via link members 60 and 70. As depicted, link members 60 and 70 are preferably rods that operate to transfer movement of actuator 20 to switch 80. Switch 80 operates to energize motor 85.

For example, a downward pressure applied to actuator 20 causes a downward movement of link 60, bias member 65, and link 70. Link 70 interfaces with switch 80 and the downward movement of the link results in the closing of the switch 80, thereby completing a circuit that energizes motor 85.

A bottom end of link 60 engages with an upper end 25 of link 70 when grinder lid 10 is disposed on grinder base 15 and a downward pressure is applied to actuator 20 sufficient to overcome the force of bias member 65 (e.g., a spring). Upper end 25 is preferably recessed below an upper surface of grinder base 15. This being recessed below an upper surface of grinder base 15 provides a degree of safety in the operation of coffee grinder 5. Arranged in this manner, the risk of unintentionally operating coffee grinder 5 is greatly reduced.

In one aspect of the present invention, grinder bin 30 is fully seated in grinder base 15 in a locked position in order for grinder lid 10, and consequently actuator 20 and link 60, to sufficiently engage with grinder base 15 and link 70 to activate the motor and grinding process, respectively.

Motor shaft 90 rotates when motor 85 is energized. Rotating motor shaft 90 rotates toothed gear 50 connected thereto. Rotating toothed gear 50 cooperatively engages with coupling 57 to rotate blade assembly 55 connected to coupling 57. In this manner, coffee beans disposed in grinder bin 30 can be ground by blade assembly 55 when actuator 20 is depressed.

In an aspect of the present invention, actuator 20 is disposed in a prominent position in or on grinder lid 10. Preferably, actuator 20 is disposed on or near an upper surface of grinder lid 10 such that actuator 20 presents a convenient and readily accessible control for coffee grinder 15. Preferably, actuator 20 extends along a substantial length of an upper surface of the grinder lid 10. Accordingly, coffee grinder 5 is preferably easily activated and controlled.

In another aspect of the present invention, motor 85 is energized so long as switch 80 is in the closed position. Thus, motor 85 is energized so long as actuator 20 is depressed. Accordingly, coffee grinder can be controlled to operate in a pulse grind mode and a continuous grind mode depending on the length of time actuator 20 is activated (i.e., depressed).

In an aspect hereof, grinder lid 10 has a circular flange 100 that extends downward from a top underside of grinder lid 10. Circular flange 100 is preferably sized to extend down into grinder bin 30 disposed in grinder base 15 when the grinder lid and the grinder base are engaged together as illustrated in FIG. 1. Circular flange 100 operates to retain coffee beans and ground coffee inside of grinder bin 30 during the coffee grinding process.

It should be appreciated that the flange's shape may be varied from that of a circle in order to matingly engage with grinder bins of differing shapes and sizes.

In another aspect of the present invention, grinder base 15 and at least a portion of grinder lid 10 are covered by a metallic finish covering 17, 19 and 12. The metallic finish covering provides a durable and aesthetically pleasing finish that can be easily cleaned.

In an aspect hereof, coffee grinder 5 of the present invention is preferably rated to operate on a 120 VAC, 60 Hz power source. The coffee grinder 5 preferably operates under a no load condition as a speed of (16,000-20,000) rpm.

It should be appreciated that the actuator, flange, and other aspects of coffee grinder 5 discussed above are exemplary of the coffee grinder of the present invention and do not preclude the inclusion, exclusion, and combination of other coffee grinder functions, controls, and other aspects thereof.

It should also be appreciated by those skilled in the art that the particular coffee grinder functions and other aspects of the teachings herein are but examples of the present invention. Thus, they do not limit the scope or variety of applications that the present invention may be suitably implemented. Thus, it should be understood that the foregoing description is only illustrative of a present implementation of the teachings herein. Various alternatives and modification may be devised by those skilled in the art without departing from the invention. Accordingly, the present invention is intended to embrace all such alternatives, modifications, and variances that fall within the scope of the appended claims.

What is claimed is:

1. A coffee grinder comprising:
a grinder bin for containing a coffee bean therein;
a grinder base for supporting said grinder bin disposed on an upper surface area of said grinder base; and
a grinder lid for covering said grinder bin, wherein said grinder bin is removably connected to said grinder base.

2. The coffee grinder of claim 1, further comprising an actuator disposed in or on said grinder lid for controlling a grinding process of the coffee grinder.

3. The coffee grinder of claim 2, wherein said actuator is disposed on an upper surface of said grinder lid.

4. The coffee grinder of claim 2, further comprising:
a link for conveying movement of said actuator; and
a switch disposed in said grinder base for controlling a motor disposed in said grinder base, wherein said link couples with said switch at a location below an upper surface of said grinder base.

5. The coffee grinder of claim 1, further comprising a motor disposed in said grinder base, said motor having a shaft for coupling to a blade in said grinder bin.

6. The coffee grinder of claim 1, further comprising a blade disposed inside of said grinder bin for grinding said coffee bean.

7. The coffee grinder of claim 1, wherein said blade is removably connected to said grinder bin.

8. The coffee grinder of claim 1, further comprising a flange mounted to an underside of said grinder lid for matingly engaging with said grinder bin disposed on said grinder base and covered by said grinder lid.

9. The coffee grinder of claim 8, wherein said flange cooperates with said grinder bin for retaining the coffee bean in said grinder bin.

10. The coffee grinder of claim 1, wherein said grinder bin disposed in a locked position on said grinder base and said grinder lid covers said grinder bin prior to operation of a grinding process of the coffee grinder.

11. The coffee grinder of claim 1, further comprising a metallic covering for said grinder base and at least a portion of said grinder lid.
